(19) United States
(12) Patent Application Publication
(10) Pub. No.: US 2014/0006124 A1
(43) Pub. Date: Jan. 2, 2014

(54) Method for Crediting a Physical Affiliate for the Sale of Digital Media by an Internet Merchant

(71) Applicant: Bitingduck Press, LLC, Altadena, CA (US)

(72) Inventor: Christian A. Lindensmith, Altadena, CA (US)

(21) Appl. No.: 13/932,558

(22) Filed: Jul. 1, 2013

Related U.S. Application Data
(60) Provisional application No. 61/666,134, filed on Jun. 29, 2012.

(51) Int. Cl. G06Q 30/02; G06K 19/077; G06K 19/06

(52) U.S. Cl. CPC G06Q 30/0214; G06K 19/06046; G06K 19/07749
USPC 705/14.16; 235/487; 235/492

(57) ABSTRACT

The disclosure relates generally to the proper sales affiliate credit and tracking of digital consumer goods, and more specifically to a method for crediting a physical affiliate for the sale of digital media to a consumer who downloads a deliverable onto their personal viewing, recording or listening device after sampling or viewing the product in the physical affiliate's location.

### INCORPORATION BY REFERENCE

The present patent application hereby incorporates by reference the provisional patent application identified by U.S. Ser. No. 61/666,134, which was filed on Jun. 29, 2012, the entire disclosure of which is hereby incorporated herein by reference.

### BACKGROUND

1. Field of the Disclosure

The disclosure relates generally to the proper sales affiliate credit and tracking of digital consumer goods, and more specifically to a method for crediting a physical affiliate for the sale of digital media to a consumer who downloads a deliverable unto their personal viewing, recording, listening, or computing device after sampling or viewing the product in the physical affiliate's location.

2. Background Information

The availability of many consumer goods in a downloadable or digital form has greatly changed the options in which consumers research, view, purchase, and utilize a desired consumer good, and consequently in the way the merchants and distributors are credited or compensated for providing the downloadable good to the consumer.

The current credit allocation systems in the art have limitations which either confine the abilities of the consumer or are not able to allow a proper credit allocation to the merchants without very restrictive conditions. One such credit allocation system is presented in U.S. Pat. No. 8,069,088, to Foulser and Clancy, which is a system and method for determining credit for a sale wherein the credit allocation relies on a system which determines the location of the electronic communication device at the time of the sale. Another example is US Publication # 20110029399, to Asher which is similar to above, but rather than use the location information to identify a single retailer to credit, the Asher publication uses the location and the distances to a number of participating retailers to determine how to credit multiple retailers. Each of the references are very focused on actual location knowledge. From a business point of view it seems like a very odd way to determine credit and commissions, since it's entirely possible (and even mentioned in the text) that none of the credited retailers may have had anything to do with the transaction.

Another allocation system present in the art involves capture rebates and discounting with web portals which is a kind of complicated referral system in which the consumer gets a rebate for being a member of a shopping site.

An additional allocation system is a shopping portal, which is a separate free Web site that has an arrangement with retailers. Retailers pay a commission to portal operators in return for sending Internet consumer traffic to the retailer's site—a kind of referral fee. When the consumer makes a purchase, the retailer pays the portal a commission. A “rebate” shopping portal goes a step further and shares its commission with the consumer.

Although, there are many types of credit allocation or consumer tracking type systems in the art, there are no known systems which work to improve the consumer experience by allowing the consumer to physically review the items in a merchants store and digitally retrieve and pay for their items at the consumers leisure at any location at virtually any time while still crediting the physical merchant. Thus, there exists a need for a more comprehensive system which balances the needs of the consumer and maintains the protection of crediting the correct physical affiliate for helping to make the digital sale of a specific good.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

The embodiments of the present disclosure generally relate to a hybrid consumer experience and merchant credit allocation system. And more specifically to a method intended primarily for products that are suitable to be delivered digitally, in which customers often like to browse in person before purchasing and further in which although the products are ultimately purchased directly from a publisher, music or film company the physical affiliate which “introduced” or “sampled” the product to the consumer is properly credited. As another example, the method is intended to present information describing a digital product on a card, flyer, or poster that can be distributed to potential purchasers. The card, flyer, or poster has codes that can be scanned by a mobile device to buy the product from an online merchant while crediting the affiliate who distributed the card, flyer, or poster.

One embodiment of the present disclosure describes a computer program product for providing credit to an affiliate for a purchase from an internet merchant. The computer program product includes a non-transitory processor readable medium. The non-transitory processor readable medium stores computer-readable program code for receiving product information identifying a digital product or group of digital products for purchase via a port of a communication device of a computer system, the product information obtained via a client device from an item identifiying the digital product and an affiliate. The non-transitory processor readable medium also stores computer-readable program code for determining that a digital product was purchased from the internet merchant via the client device, for delivery of the digital product to a recipient device, and for providing a credit to the affiliate based on determining that the product information obtained via the client device identifies the affiliate and determining that the digital product was purchased from the internet merchant using the product information.

In another embodiment, the present disclosure describes a processor readable medium storing one or more software program that when executed by a processor causes the processor to receive product information identifying a digital product or group of digital products for purchase and an affiliate via a port of a communication device of a computer system, the product information obtained via a client device from an item identifying the digital product and an affiliate. The software program further causes the processor to determine that the digital product was purchased by a user of the client device from an internet merchant via the client device and deliver the digital product or group of digital products to a user of the client device. The software program finally causes the processor to provide a credit to the affiliate based on determining that the product information identifies the affiliate and determining that the digital product was purchased from the internet merchant using the product information.

In another version, the present disclosure describes a processor readable medium storing one or more software program that when executed by a processor causes the processor to receive information indicative of a digital product for purchase and an affiliate via a port of a communication device of a computer system, the information obtained from an item associated with the affiliate and received from a client device, and wherein the information is an optically or radio frequency readable code linked to an internet site of a predetermined internet merchant. The software program further causes the processor to effect a transaction for the digital product with the client device, make the digital product available to a recipient device, and provide a credit to the affiliate based on determining that the information identifies the affiliate and determining that the digital product was purchased from the internet merchant using the information.

In another embodiment, the present disclosure describes a product identifier card having a substrate with a first surface and a second surface opposite the first surface, a first information affixed to at least one of the first and second surfaces of the substrate, and a second information affixed to at least one of the first and second substrates. The first information is indicative of a digital product and an affiliate. The second information represents a digital product identified by the first information.

In one embodiment, the present disclosure describes a system for providing credit to an affiliate for a purchase from an internet merchant different from the affiliate. The system includes a product identifier card, a client device, a computer system, a database, and an affiliate crediting module. The product identifier card has a substrate, a first information affixed to the substrate and a second information affixed to the substrate. The first information is indicative of a digital product and an affiliate, and the second information represents a digital product identified by the first information. The client device is configured to read the first information. The computer system has a processor, a non-transitory processor readable medium in communication with the processor, and a communication device having at least one port and in communication with the processor. The computer system receives the first information identifying the digital product and the affiliate from the client device via the port of the communication device of the computer system. The first information obtained from the product identifier card associated with the affiliate. The database is stored on a non-transitory processor readable medium. The database stores second information indicative of a plurality of affiliates. The affiliate crediting module has one or more software program stored on a non-transitory processor readable medium that when executed causes a processor to determine an identity of the affiliate from the first information and the second information. The software program also causes the processor to determine whether the digital product was purchased from an internet merchant associated with the database and the computer system. The software program further causes the processor to provide credit to the affiliate within the database based on determining that the first information identifies the affiliate and determining that the digital product was purchased from the internet merchant using the information.

One embodiment of the present disclosure includes a method for crediting a physical affiliate for the sale of digital media by an internet merchant comprising a) developing a physical affiliate database with information associated with participating retailers, including retailer identification; b) supplying a physical affiliate or a potential customer with optically or radio frequency readable codes identifying the product and the physical affiliate on a card, flyer, or poster; and c) having a customer select a product from the physical affiliate or from the card, flyer, or poster and using an electronic device to read the optically or radio frequency readable code for the desired product and complete an internet purchase and product download onto their electronic device.

In another embodiment, a “product identifier” created may lead the consumer to a list of options to purchase which would still be identifiable to both the publisher and the physical affiliate. For example, a consumer enters a store and listens to music from an artist they find interesting, the consumer grabs the product identifier card related to the artist rather than just an album, and when the product identifier card is scanned the options are to purchase individual songs, individual albums, or all albums.

In another embodiment related to digital or e-books a book, a book series or collection based on a specific author, authors or series may by identified by a product identifier card, the card is picked up by the consumer and when scanned the options are to check boxes of a book or the books in the series or the list the consumer would like to purchase and download.

In another embodiment, a physical affiliate adds value to the process by creating product identifier cards which may contain their employees' favorite books or movies, on the card or movies by actor on a product identifier card. Another example is the basic concept of the physical affiliate creating compilations or groupings of materials based on various tastes, or themes or criteria e.g. 2012 Joes bookstore book of the month compilations, Holiday favorites, employees funniest movies lists.

In yet another embodiment the product identifier card may also enable a sample of the product available to purchase to be displayed for consumer review and recollection before purchasing.

### BRIEF DESCRIPTION OF THE DRAWINGS

Certain embodiments of the present inventive concepts will hereafter be described with reference to the accompanying drawings, which are not intended to be drawn to scale, wherein like reference numerals denote like elements. For purposes of clarity, not every component may be labeled in every drawing. Certain features and certain views of the figures may be shown exaggerated and not to scale or in schematic in the interest of clarity and conciseness. A more complete appreciation of the inventive concepts disclosed herein and many of the attendant advantages thereof will be readily understood by reference to the following detailed description with taken in conjunction with the accompanying drawings.

FIG. 1 is a schematic diagram which details a consumer experience integrating a client device, an internet merchant, an affiliate retailer and an optical code, in accordance with the present disclosure.

FIG. 2 is a schematic diagram which details a method for crediting an affiliate such as a physical retailer for the sale of digital media by an internet merchant.

FIG. 3 is a schematic diagram which details a method for supplying a physical affiliate with optically or radio frequency readable codes identifying product and physical affiliates.

FIG. 4 is a schematic diagram of a method for customer product selection and completion of an interne purchase.

FIG. 5 is a schematic diagram showing a method for receiving URI with product and physical affiliate identifiers.

FIG. 6 is a front elevational view of an embodiment of a product identifier card constructed in accordance with the present disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts disclosed herein may be practiced without these specific details. In other instances, well-known features have not been described in detail to avoid unnecessarily complicating the instant disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment, although the inventive concepts disclosed herein are intended to encompass any and all combinations and permutations of the features of the embodiments described herein.

Finally, as used herein qualifiers such as “about,” “approximately,” and “substantially” are intended to signify that the item or value being qualified is not limited to the exact value or amount specified, but includes some slight variations or deviations therefrom, caused by measuring error or imprecision, manufacturing tolerances, stress exerted on various parts, wear and tear, and combinations thereof, for example.

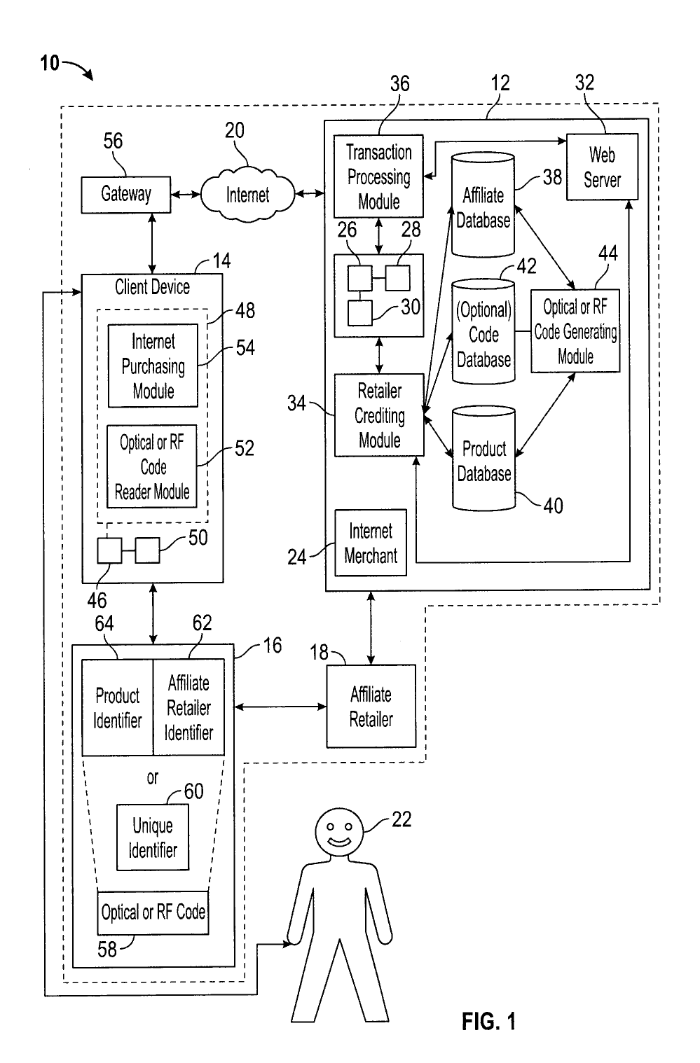

Referring now to FIG. 1, therein shown is an affiliate crediting system 10 for providing products to a customer and allocating credit to an affiliate which introduced the product to the customer. The affiliate crediting system 10 may include an internet merchant block 12, a client device block 14, and an optical or radio frequency code block 16. As will be appreciated by one skilled in the art, with the benefit of the present disclosure, the affiliate crediting system 10 may be implemented with hardware, such as web servers, processors, non-transitory processor readable media, and the like, and software, such as computer program products, computer-readable program code, firmware, and the like. The internet merchant block 12 may be designed and configured to pair product information and information of an affiliate 18 and to receive web server requests from the client device block 14, via a computer network 20, indicative of the product and affiliate information for the purposes of purchasing a product and crediting an affiliate 18 responsible for introducing the product. The internet merchant block 12 is also configured, in some embodiments, to generate codes containing product information and affiliate information and to supply such codes to the optical code block 16. The client device block 14 is configured to optically or by radio frequency read the codes generated by the internet merchant block 12 from the optical code block 16 and submit server requests, including the product information and the affiliate information, to the internet merchant block 12 indicative of a desired transaction for a product. The optical or radio frequency code block 16 presents the codes generated by the internet merchant block 12 associating the product information and the affiliate information to the client device 14. The methods embodied in the present disclosure include interactions by at least three participants: a customer (“customer 22”), an internet merchant (“internet merchant 24”) and the affiliate 18, such as a retailer or party with a physical presence (“affiliate 18”). A schematic representation of an exemplary interaction of the three participants is presented in FIG. 1.

Internet Merchant Block 12:

The internet merchant block 12 may be implemented as a computer system with a processor 26, a non-transitory processor readable medium 28 in communication with the processor 26 and capable of storing processor executable instructions (i.e. software and firmware), a communications device 30 in communication with the processor 26, an input device (not shown) coupled to the processor 26, and an output device (not shown) coupled to the processor 26. In some embodiments, the internet merchant block 12 may also include a web server 32, a retailer crediting module 34 (which may also be referred to hereinafter as an affiliate crediting module 34), and a transaction processing module 36. In some embodiments, the web server 32 may include the retailer crediting module 34 and the transaction processing module 36. The internet merchant block 12 and/or the web server 32 may be configured to receive server requests containing the product information and the affiliate information and representing a request for a desired transaction for the digital product or group of digital products. In some embodiments, the web server 32 may supply the request to the transaction processing module 36 and the retailer crediting module 34. The retailer crediting module 34, described in more detail below, may be configured to map server requests into affiliate and product identities. The retailer crediting module 34 may include an algorithm that maps the server requests to affiliate and product identities or may use an additional database that allows mapping of arbitrarily constructed server requests into product and affiliate identities. The transaction processing module 36, described in more detail below, may be configured to accept payment or credit from the customer 22 and return validation that the customer 22 has paid for a particular product such that the particular product may be delivered to the customer 22. Thus, the transaction processing module 36 may be programmed in a way so as to effect the transaction with the customer 22 without having or requiring any participation in the transaction by a point of sale or other system owned or operated by the retailer.

The processor 26 of the internet merchant block 12 may be any type of processor such as a central processing unit, a graphics processing unit, a visual processing unit, and combinations thereof. The non-transitory processor readable medium 28 of the internet merchant block 12 may be implemented as any type of memory, such as random access memory (RAM), read only memory (ROM), a CD-ROM, a hard drive, a solid state drive, a flash drive, a memory card, a DVD-ROM, a floppy disk, an optical drive, and combinations thereof, for example. The communications device 30 of the internet merchant block 12 may be configured to enable the processor 26 to communicate with the computer network 20, such as the internet, and one or more client device, denoted by the client device block 14. The communications device 30 may have one or more ports and may be implemented as an optical communications device; a wired communication device, such as a universal serial bus (USB), an IEEE 1394 port, or other wired communications devices; or a wireless communication device, such as a WiFi radio, an antenna, or other wireless communications device. The input device of the internet merchant block 12 may be implemented as a keyboard, a touchscreen, a microphone, a camera, an optical code reader, or any other input device capable of transmitting signals from a user to the processor 26. The output device of the internet merchant block 12 may be a printer, monitor, touchscreen, speakers, or any other output device capable of transmitting signals from the processor 26 to the user in a user perceivable format.

The web server 32 may be a standard general purpose web server 32 with general purchase store software and implemented as a computer system integral to or remote/distributed from the internet merchant block 12. As one skilled in the art would appreciate, the web server 32 may be implemented similarly to the internet merchant block 12 with a processor (not shown), a non-transitory processor readable medium (not shown), an input device (not shown), an output device (not shown), and a communications device (not shown). The web server 32 may also be a specifically designed web server 32 that can send requests to the client device 14 to record images or signals from an optical reader or scanner of the client device 14. An example of this usage is if the web server 32 is activated by the customer 22 scanning a code that indicates that a general purpose web browser should go to an internet site of the internet merchant 24 and run a software program either on the web server 32 or on the client device 14. The software program can then request an image or scan data from the imaging or scanning hardware of the client device 14 when the customer 22 indicates to the program a desire to purchase a digital media product or group of digital products. The customer 22 then scans the standardized code (e.g. ISBN or EAN13) to indicate to a purchasing module on the client device 14 the particular digital media product and transmits the request to the web server 32 (in the case of a client side program) or to the transaction processing module 36 and the retailer crediting module (in the case of a server side program).

The web server 32 may include a web server module which may be any one of many possible standardized modules, implemented with hardware and software, for processing data over the computer network 20, or the web server 32 may use a unique protocol custom built for use by the internet merchant 24, or some combination of the two. The web server module may supply the web server 32 with standardized software for accepting messages transmitted via the protocols of the computer network 20, such as the world-wide-web, by the customer 22 using a generic browser, or the web server 32 might include a custom module for accepting messages and communicating with a customer application dedicated to the products of the internet merchant 24. The customer application would be executed on a device controlled by the customer 22 (e.g. a mobile phone application on a customer's mobile phone). The web server 32 also is responsible for making the purchased product available to the customer 22, either by making the product available for use in the customer's account directly on the server (e.g. view on the server or download from the server), making the product available for use on another device or software system (e.g. purchase using a mobile phone and make available for an e-reader or e-reader application), electronically mailing the product (e.g. as an email attachment) or otherwise making the product available for transmission to the user.

The retailer crediting module 34, as shown in FIG. 1, may include an affiliate database 38 and a product database 40. However, in some embodiments, the affiliate database 38 and the product database 40 may be in communication with but not implemented within the retailer crediting module 34. The affiliate database 38, implemented with hardware and software, is a database that contains information about the physical affiliates 18 and information that may enable mapping the web server requests to affiliates 18, as well as to provide credit to the affiliate 18 for sales to the customer 22. The product database 40, implemented with hardware and software, is a database that contains information about the digital products or groups of digital products that may enable mapping the web server requests to products. The product database 40 may also contain digital copies of the products, information to create the digital products, or pointers to files, servers, or other data storage systems containing or capable of containing or generating the digital products for delivery. In one embodiment, the affiliate database 38 and the product database 40 may be implemented as software on the non-transitory processor readable medium 30 of the internet merchant block 12. In other embodiments, the affiliate database 38 and the product database 40 may be implemented as software on the non-transitory processor readable medium of the web server 32. In still other embodiments, the affiliate database 38 and the product database 40 may be implemented as separate servers (e.g. web servers) in communication with the internet merchant block 12, the web server 32, and/or the retailer crediting module 34.

The retailer crediting module 34, as shown, may also include a code database 42. However, in some embodiments, the code database 42 may be in communication with but not implemented within the retailer crediting module 34. The code database 42 may be implemented with hardware and software, for example as a software module stored on the non-transitory processor readable medium 30 of the internet merchant block 12 or the non-transitory processor readable medium of the web server 32. The code database 42 may also be implemented as a separate server (e.g. web server) remote/distributed from and in communication with the internet merchant block 12, the web server 32, and the retailer crediting module 34. Using the code database 42, the retailer crediting module 34 may use arbitrary server requests to map product and affiliate 18 identities. For example, each individual optically or radio frequency readable code may be unique (such as a simple sequence of numbers) and each number is associated in the code database 42 with an affiliate 18 and a product. In this example, there might be just one or many numbers that map to a particular affiliate 18 and product pair, creating a one-to-one or many-to-one database relationship. This case of arbitrarily mapping could be used to track the customer history of a single optically or radio frequency readable code. The code database 42 may be used when the internet merchant block 12 or the retailer crediting module 34 does not use an algorithmic method of converting the web server request into product and affiliate 18 identities. An example of this is if the internet merchant 24 generates a large number of unique codes that are not associated with any product or affiliate 18, and then after code generation maps each of the codes to a product and affiliate 18. Another example is if the internet merchant 24 generates a large number of codes that are associated to identify a particular product, but not to a particular affiliate 18. The affiliate 18 identification would be done by mapping a code to an affiliate 18 and storing that code in the code database 42. Another example is where the internet merchant 24 generates a large number of codes that are associated to a particular product, but have a predictable (e.g., Sequential) identifier for the affiliate 18 identifier. A set of codes could be given to an affiliate 18 such that the start and end of the sequence are noted and associated in the code database 42 to the particular affiliate 18, even though each of the codes is unique. This method allows individual tracking of the use of the codes.

In one embodiment, as shown, the code database 42 may include a product code generating module 44, also hereinafter referred to as an optical or radio frequency code generating module 44, which may be implemented as software executed by suitable hardware. For example, the code generating module 44 may be implemented as software on the non-transitory processor readable medium 28 of the internet merchant block 12, the non-transitory processor readable medium of the web server 32, or non-transitory processor readable medium of the retailer crediting module 34. However, in some embodiments, the product code generating module 44 may be implemented separately from the code database 42 within the internet merchant block 12 or remote/distributed from the internet merchant block 12, on a separate web server, for example. The product code generating module 44 produces optically or radio frequency readable codes that are scanned by the customer 22 to buy the product identified by the codes. The optical or radio frequency code generating module 44 may be operated by the internet merchant 24, by the affiliate 18, or potentially even a third party who generates codes based on information supplied by the internet merchant 24. The optical or radio frequency code generating module 44 uses any of a number of possible ways to combine the information of affiliate 18 identity, product identity, and any additional desired information and generate an optically or radio frequency readable code. If the code is to be read by a software that is not custom to the internet merchant 24, the code will include information identifying the internet merchant 24 (e.g. an internet URI). If the code is to be read by a software that identifies the internet merchant 24 by another means (e.g. is custom to that internet merchant 24 or a set of merchants and has a selector) then the code need not contain an identifier for the internet merchant 24. Two general (but not the only) methods would be algorithmic and database linked, which will be described in more detail below. In the algorithmic method the optical or radio frequency code generating module 44 would combine the affiliate 18 identity and the product identity into a web server message in a predictable way such that knowledge of the web server message would allow any person or machine with knowledge of the algorithm to reconstruct the way to look up the product and affiliate 18 in the affiliate and product databases 38 and 40, respectively. In the database linked method, the optical or radio frequency code generating module 44 constructs a database record (in the optional code database 42) that maps a webserver message to a product and affiliate 18 pair. The codes generated by the optical or radio frequency code generating module 44 can be any number of currently existing or not yet invented optically or radio frequency readable codes. Examples are common bar codes (e.g. EAN13), QR codes, radio frequency identifier codes, and near field communication codes. The codes could also include combinations of two or more types of code, e.g. a QR code identifying the affiliate and an EAN13 or ISBN code identifying the product.

The affiliate crediting system 10 can be implemented in a way that the standard ISBN code that is provided on all physical books for sale can be supplemented with an additional code to indicate the affiliate 18 and optionally the internet merchant 24. The code to indicate the affiliate 18 could be generated by the internet merchant 24 or the affiliate 18. The code may be provided as part of an extended ISBN code such that it does not interfere with standard ISBN readers (which expect a certain amount of whitespace) but can be read by readers expecting an extended or enhanced ISBN, similar to how price codes are currently printed on physical books alongside an EAN13/ISBN code. In the case of an extended ISBN code using a second code to indicate the affiliate 18, the code can optionally indicate the internet merchant 24. The additional code indicating the internet merchant 24 and affiliate 18 can be scanned sequentially or simultaneously with the code indicating the product.

The affiliate crediting system 10 can also be implemented so that the codes indicating the affiliate 18 and internet merchant 24 are presented separately from the code indicating the item. An example of this would be a bookstore that provides a separate card, sheet, or poster printed with the internet merchant 24 and affiliate codes to customers 22 who then scan the separate card, sheet, or poster along with the ISBN or other code already printed on the book in order to purchase an electronic version of the book. This example may be applied similarly to music recordings, motion picture recordings, or computer software by substituting the use of the appropriate codes that are already commonly printed on the packaging (e.g. EAN13 bar codes) for the ISBN code in the example.

The transaction processing module 36 may be any module, implemented as hardware and/or software, commonly available, or a custom module, which processes transactions between the customer 22 and the internet merchant 24. For example, the transaction processing module 36 may be implemented on the non-transitory processor readable medium 28 of the internet merchant block 12, the non-transitory processor readable medium of the web server 32, or may be implemented separate and/or remote from the internet merchant block 12 and/or the web server 32, for example as a separate web server. The transaction processing module 36 accepts payment or credit of some form from the customer and returns validation that the customer 22 has paid for a particular product and that the product may be delivered to the customer 22. The transaction processing module 36 can also track customer 22 and affiliate 18 history so that a given affiliate 18 might receive additional commissions based on purchases from a particular one of the customer 22 who previously purchased from the internet merchant 24 using the system described herein.

In another embodiment, the transaction processing module 36 may track the customer 22 and the affiliate 18 history so that one or more of the particular affiliate 18 may receive credit for an extended period after the customer 22 has made a purchase. For example, if the customer 22 were to receive an optically or radio frequency readable code from a first affiliate 18a and make a purchase, then at a later time makes another purchase directly from the internet site of the internet merchant 24 without scanning the optically or radio frequency readable code or returning to the affiliate 18a, the affiliate 18a may still receive a credit for the later sale, even though the customer 22 may have had no additional contact with the affiliate 18a or the optically or radio frequency readable code. In another embodiment, the transaction processing module 36 may be configured to divide credit between two or more of the affiliate 18. For example, the customer 22 receives a first optically or radio frequency readable code from the first affiliate 18a and makes a first purchase. Then the customer 22 receives a second optically or radio frequency readable code from a second affiliate 18b and makes a second purchase. The second purchase may be divided according to the relative number of times the customer 22 brought from the internet merchant 24 after scanning first optically or radio frequency readable code and the second optically or radio frequency readable code. To elaborate, if the customer 22 bought something after scanning the first optically or radio frequency readable code from the first affiliate 18a and two other things after scanning two optically or radio frequency readable codes from the second affiliate 18b, then later bought a fourth item independent of the first affiliate 18a and the second affiliate 18b, the first affiliate 18a may receive one third of the credit and the second affiliate 18b may receive two thirds of the credit for the fourth item, for example. It should also be understood that other formulas for dividing the credit between the affiliates 18 may be used.

The transaction processing module 36 may be additionally operated in whole or in part by a fourth party (“transaction processor”). Any part of the transaction handling may be handled from the internet merchant 24 to the transaction processor. For example, the transaction processor may include a payment clearinghouse who accepts funds or credit on behalf of the internet merchant 24 and returns a confirmation of payment to the internet merchant 24 so that the internet merchant 24 can know that the digital product or group of digital products is paid for prior to delivery.

The internet merchant block 12, for a particular internet merchant 24, may include hardware and software to serve as a pre-processor for one or more additional internet merchants (“additional merchant”). In this case the internet merchant block 12, for a particular internet merchant 24, processes the request that is sent from the client device 14 to the internet merchant block 12 and looks up in the product database 40 which additional merchant or merchants will handle the transaction. The internet merchant block 12 then redirects the customer 22 to the additional merchant. When the internet merchant block 12 redirects the customer to the additional merchant, the internet merchant block 12 may include information so that the affiliate 18 can then be properly credited for the transaction. The additional information can be information identifying the affiliate 18 or the additional information can be a key or other token that may be used by the internet merchant block 12 to identify the transaction (“transaction identifier”). In the case where the internet merchant block 12 of the internet merchant 24, sends a transaction identifier, the additional merchant credits the internet merchant 24 who then handles crediting of the transaction to the affiliate 18.

For example, a physical bookstore carries books by a number of publishers. Each book is marked with a code indicating the book. When a customer 22 chooses to buy the e-book rather than the printed book, the customer 22 scans the ISBN code on the back of the book and an additional code indicating the affiliate 18 using the client device 14 and a program specific to the internet merchant 24. The web server 32 at the internet merchant block 12 then receives the message from the client device 14 and looks up the book in the product database 40. The product database 40 contains information to redirect the customer 22 to the publisher. The internet merchant block 12 then redirects the customer 22 to the publisher (who acts as the “additional merchant”) who completes the transaction and delivers the electronic version of the book to the customer 22. The redirection can be transparent to the customer 22 or can be so that the redirection is obvious to the customer 22. This example is applicable for any form of digital media, including electronic books, music, motion pictures, and computer software.

The above example also is applicable when the customer 22 initially scans a code that directs the customer 22 to the internet merchant block 12, for example to the web server 32, along with information identifying the affiliate 18. The internet merchant block 12 then executes a software program on the internet merchant block 12 or on the client device 14 that enables the customer 22 to scan further codes that identify products that the customer 22 chooses to scan for purchase. After the customer 22 selects a product or products and chooses to complete the transaction, the software then passes the transaction information to the transaction processing module 36 for completion of the transaction. This last example is effectively self-checkout in a physical store selling digital products or groups of digital products for delivery by their producers or representatives (i.e. the internet merchant 24 serves as a clearinghouse/redirector for sale of digital media products by their publishers, who then credit the physical affiliate 18 for providing a “showroom”).

The Client Device Block 14

The one or more client device 14, as denoted by the client device block 14, may be a computing device with a camera or other optical or radio frequency code reader that the customer 22 uses for accessing the computer network 20. The client device 14 may be provided with a processor 46, a non-transitory processor readable medium 48, an input device (not shown), an output device (not shown), and a communications device 50. In some embodiments, the processor 46 of the client device 14 may be implemented similarly to the processor 26, described above. Similarly, in some embodiments the non-transitory processor readable medium 48 of the client device 14 may be implemented similarly to the non-transitory processor readable medium 28, described above. The non-transitory processor readable medium 48 may include a code reader module 52 and an internet purchasing module 54, stored thereon, which will be described in more detail below. In some embodiments, the input and output of the client device 14 may be implemented similarly to the input device and the output device of the web server 32, respectively. Further, in some embodiments the communications device 50 of the client device 14 may be implemented similarly to the communication device 30, described above. In some embodiments, the input may be the optical or radio frequency code reader, while in other embodiments the optical or radio frequency code reader may be implemented separately from the input of the client device 14. The client device 14 may communicate with the computer network 20 via a gateway 56, which will be described in more detail below.

The client device 14 may be implemented as a mobile phone, a tablet computer, an electronic book reader, a music player, a laptop computer, a desktop computer, a handheld gaming system, or any other data processing device that is attached to an optical or radio frequency code reader. The optical or radio frequency code reader may be implemented as a camera, optical scanner, near field communication reader, or other barcode or radio frequency identifier reader. The client device 14 may be connected to the computer network 20 by the communications device 50 within the client device 14 such that the client device 14 is able to communicate with the web server 32 of the internet merchant block 12.

The code reader module 52 may be stored on the non-transitory processor readable medium 48 of the client device 14. The optical or radio frequency code reader module 52 is a software, firmware, or other program on the client device 14 that is capable of detecting an optically or radio frequency readable code and converting the readable code back into the message, containing information indicative of the product and the affiliate 18. The code reader module 52 may be a camera with software for interpreting the code, a scanner with software for interpreting the code, or a laser barcode reader with software for interpreting the code. The code reader module 52 may also send the code to an external server for translation. In any event, the code reader module 52 accepts the input code and translates the input code back into the original message to be sent to the internet merchant block 12. The code reader module 52 can be a general purpose code reader module. Many such modules are readily available to read a number of types of optically and radio frequency readable code. The code reader module 52 can also be a software program that is specific to the affiliate 18, the internet merchant 24, or some group of merchants. In the case where the code reader module 52 is specific to the affiliate 18 or internet merchant 24, the code reader module 52 may be programmed to correctly identify the internet merchant 24 without the need for the internet merchant's web address being encoded in the optically readable code. In a case where the code reader module 52 is associated with a group of merchants, the code reader module 52 may optionally have a selection control so that the customer 22 can identify the internet merchant 24. The customer 22 may use the camera, scanner, or other reader, of the client device 14, to input the optically or radio frequency readable code to the optical or radio frequency code reader module 52 that may translate the code into the message described above and pass the message to the internet purchasing module 54.

The internet purchasing module 54 may be stored on the non-transitory processor readable medium 48 of the client device 14. The internet purchasing module 54 is a software or firmware that allows the user of the client device 14 to make purchases over the internet. The internet purchasing module 54 may include a generic world-wide-web browser or a software program particular to the internet merchant 24 or to some set of merchants. The internet purchasing module 54 may also set an identifier (e.g. bookmark, “cookie”, or session key) so that the customer can scan the product at one time and then return and purchase the product without rescanning, but with the affiliate 18 still receiving credit. The internet purchasing module 54 on the client device 14 can be a general purpose browser or a software program specific to the affiliate 18 or internet merchant 24. The internet purchasing module 54 may be designed to scan codes sequentially or simultaneously or be capable of either at the option of the user. The internet purchasing module 54 may take advantage of application program interfaces in the client device 14 to allow a standard web browser or other software program to record images or signals from the optical reader or scanner of the client device 14. The internet purchasing module 54 and the optical or radio frequency code reader module 52 can be provided as separate client device 14 applications or can be integrated into a single client device 14 application.

The Optical or Radio Frequency Code Block 16:

The optical or radio frequency code block 16 includes an optically or radio frequency readable code 58 that contains the information needed by the internet merchant block 12 to map a message in the optically or radio frequency readable code 58 back to the affiliate 18 and product pair. The optical or radio frequency code block 16 may be implemented as a card, flyer, sticker, poster, or other display, as will be described in more detail below. Depending on details of the rest of the implementation, the optically or radio frequency readable code 58 may contain various information. In the most general case the optically or radio frequency readable code 58 may contain an internet address of the internet merchant block 12 and an identifier 60 that the internet merchant block 12 can map back into an affiliate 18 and product pair. The optically or radio frequency readable code 58 may also contain information for the internet merchant 24 that tells what part of the web server 32 should process the message, and may contain other identifiers used for tracking or processing. The optically or radio frequency readable code 58 may also contain distinctly identifiable pieces of the message, such as an affiliate identifier 62, indicative of an affiliate in the affiliate database 38 and/or a product identifier 64, indicative of a digital product or group of digital products in the product database 40. The optically or radio frequency readable code 58 may also be designed so that the optically or radio frequency readable code 58 does not contain the internet address of the internet merchant block 12 or the web server 32 that should process the message, but may be provided along with information as to what web server should process the message (i.e. the optically or radio frequency readable code 58 may be labeled to indicate association with a particular internet merchant so that the customer 22 knows to use a software application associated with that internet merchant to read the optically or radio frequency readable code 58).

The optically or radio frequency readable code 58 may also be one or more of many types. There are a number of well specified optical, radio frequency, or near field code protocols available, including one dimensional barcodes (e.g. EAN13 or ISBN) and 2-dimensional codes (e.g. QR, Aztec, or MaxiCode) that are available, Electronic Product Code, ECMA-340 or the optically or radio frequency readable code 58 could be a new implementation.

The optically or radio frequency readable code 58 may be presented to the customer 22 any number of ways. In the case of a digital product or group of digital products that are also available as a physical product (e.g. book, music compact disc, vinyl record, packaged software product, motion picture DVD) the optically or radio frequency readable code 58 may be affixed directly to the product at the location of the physical affiliate 18. The optically or radio frequency readable code 58 may also be affixed to a shelf near where the product is displayed. The optically or radio frequency readable code 58 can also be affixed to a card or flyer and put in the product (e.g. in a book) or in a holder near the product. Implementation of the optically or radio frequency readable code 58 on a card, flyer, poster, or similar material will be discussed in more detail below.

The computer network 20 may interface with the client device 14 and the web server 32 in a variety of ways, such as by optical, wireless, wired, and/or electronic interfaces. The computer network 20 may permit bi-directional communication and interfaces of data and/or information between the web server 32 and the client device 14. In some embodiments, the computer network 20 may be the internet. The internet is a global data communication network that allows transmission of data by a number of protocols and topographies. The protocols and topographies used by the computer network 20 may include TCP/IP, Ethernet, circuit switched paths, and combinations thereof.

In some embodiments, the client device 14 may communicate with the computer network 20 via the gateway 56. The gateway 56 may be a generic external system that the client device 14 of the customer 22 uses for accessing the computer network 20. The gateway 56 may be implemented as a wireless router, a wired router, a cellular phone network, a 3G network, a 4G network, a web server, a server, an internet service provider, a cellular phone service provider, or any combination thereof.

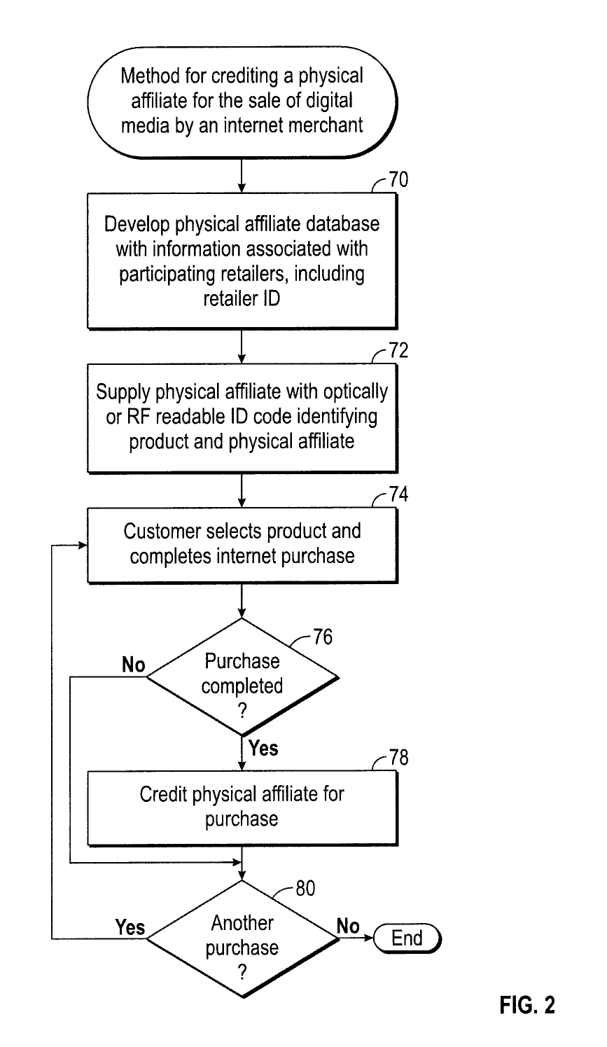

Referring now to FIG. 2, shown therein is an exemplary method for crediting a physical affiliate 18 for the sale of a digital product by an internet merchant 24. The physical affiliate 18 and the internet merchant 24 may establish a relationship at the start of the process. The internet merchant 24 may then develop a database that contains information about its products, the product database 40; a database of merchants or affiliates, the affiliate database 38; and a software module, the retailer crediting module 34, to map server requests into affiliate identities and product identities.

The first step in the method may be to develop the physical affiliate database 38 with information associated with participating affiliates, such as retailers, merchants, authors, and the like, as indicated by block 70. The affiliate database 38 may include the affiliate identifier 62 for each affiliate 18, as further indicated by block 70. The next step is to supply the physical affiliate 18 with the optically or radio frequency readable codes 58 identifying the product and the physical affiliate 18, as indicated by block 72. The customer 22 next selects the product and completes the internet purchase, as indicated by block 74 and explained in more detail below. If the purchase is completed, as indicated by block 76, the physical affiliate 18 is credited for the purchase, as indicated in block 78. If the purchase is not completed, the customer 22 may be prompted to make another purchase, as indicated by block 80, wherein the customer 22 may repeat the steps indicated by blocks 74 and 76. When the purchase is completed, the customer 22 may be prompted to make another purchase, as indicated in block 80. Choosing to make another purchase, the customer 22 may repeat the steps indicated by blocks 74 and 76. Where the customer completes the purchase, as indicated in block 76, and another purchase is not requested, the physical affiliate 18 is credited for the purchase, as indicated in block 78.

As previously referenced, the internet merchant block 12 may use the algorithmic lookup method or may use the database lookup method. For example, where the internet merchant block 12 uses the algorithmic lookup method, at the start of the relationship of the affiliate 18 with the internet merchant 24, the affiliate 18 agrees to carry the internet merchant's product with the identification number 2718, e.g. the product identifier 64. The internet merchant 24 assigns affiliate identification number 314, e.g. the affiliate identifier 62, to the affiliate 18. The internet merchant 24 has a website at “http://www.example.com”. The optical or radio frequency code generating module 44 then constructs a message such as “http://www.example.com/store/2718/314” and generates the optically or radio frequency readable code 58:

This optically or radio frequency readable code 58 is supplied to the affiliate 18, who

attaches the optically or radio frequency readable code 58 to a representation of product 2718 (e.g. a free postcard with the artwork for an electronic book). The customer 22 browses the bookstore and is interested in product 2718. The customer 22 is uncertain about the purchase however, but takes the free postcard as a reminder. The customer 22 later decides to purchase the book and scans the optically or radio frequency readable code 58 with a smartphone, e.g. the client device 14. The client device 14 uses a commonly available optical or radio frequency code reader module 52 to translate the optically or radio frequency readable code 58 back into the message “http://www.example.com/store/2718/314” and sends that message out over the computer network 20, such as the internet. The message is received by the web server 32 at the internet merchant block 12 (because the internet merchant block 12 has the address http://www.example.com) and executes the transaction processing module 36 and the affiliate crediting module 34. The affiliate crediting module 34 extracts the product identifier 64 (2718) and affiliate identifier 62 (314) from the message. The affiliate crediting module 34 passes the information to the transaction processing module 36, which completes the transaction and sends a completed transaction message back to the affiliate crediting module 34 which credits the affiliate 18 and makes the purchased electronic book available to the customer 22.

Where the internet merchant 24 uses the database lookup method, at the start of the relationship of the affiliate 18 with the internet merchant 24, the affiliate 18 agrees to carry the merchant's product with the identification number 2718, the product identifier 64. The internet merchant 24 assigns affiliate identification number 314, the affiliate identifier 62, to the affiliate 18. The internet merchant 24 has a website at “http://www.example.com”. The internet merchant 24 uses the optical or radio frequency code generating module 44 to create codes number 1000 through 1999. The internet merchant 24 then associates numbers 1000 through 1999 with the affiliate/product pair 2718/314, the affiliate identifier 62 and the product identifier 64, and stores this association in the code database 42. The internet merchant 24 then generates unique optically or radio frequency readable codes 58 representing the messages of the form “http://www.example.com/store/XXXX” where “XXXX” is one of the numbers 1000 through 1999. The customer 22 browses the bookstore and is interested in product 2718. The customer 22 is uncertain about the purchase however, but takes the free postcard (e.g. number 1499) as a reminder. The customer 22 later decides to purchase the book and scans the optically or radio frequency readable code 58 with a smartphone, the client device 14. As in the previous example the client device 14 decodes the optically or radio frequency readable code 58 into a message to the web server 32, but the message is now “http://www.example.com/store/1499”. The web server 32 sends the “1499” to the affiliate crediting module 34 which then looks in the code database 42 to see that affiliate 314, the affiliate 18, should be credited with a sale of product 2718 when the transaction is complete, and then makes available to the customer 22 a copy of product 2718.

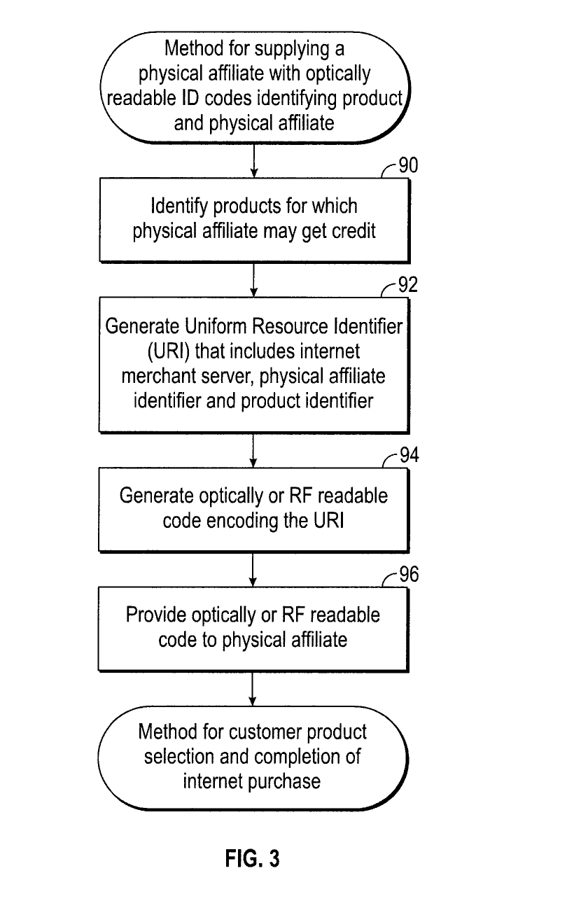

Referring now to FIG. 3, therein shown is an exemplary method for supplying a physical affiliate 18 with optically or radio frequency readable codes 58 identifying the products and the physical affiliate 18.

The first step in the method is to identify the products for which the physical affiliate 18 may get credit, as indicated by block 90. The next step is to generate a Uniform Resource Identifier (URI) that includes the internet merchant 24 server, physical affiliate identifier 62 and a product identifier 64, as indicated by block 92. The optically or radio frequency readable code 58, encoding the URI, is generated, as indicated by block 94 and the optically or radio frequency readable code 58 is provided to the physical affiliate 18, as indicated by block 96.

The first step, indicated by block 90, in the above method is to “identify products for which the affiliate 18 may get credit”. This step is where an affiliate 18 would select their catalog of items to present. Many affiliates 18 may not want to present the complete catalog of a particular internet merchant 24. Instead, the affiliate 18 might select their own favorite products or a set of products within their catalog, or a set of products consistent with their other business. A beauty salon could choose to be the affiliate 18 seller of health and beauty ebooks. A live music venue could choose to present music by artists who have recently played there or will soon play there for affiliate 18 sales. A bookstore or music store might choose to present catalogs from a number of competing internet merchants 24. The software at the internet merchant 24 could also be designed so that the affiliate 18 can set its own retail price for the product higher than a minimum set by the internet merchant 24, thus setting its own commission, while the internet merchant 24 might collect a fixed (or otherwise negotiated) portion of the sale. This would enable affiliates 18 to offer special promotions or otherwise compete with each other while selling the same product.

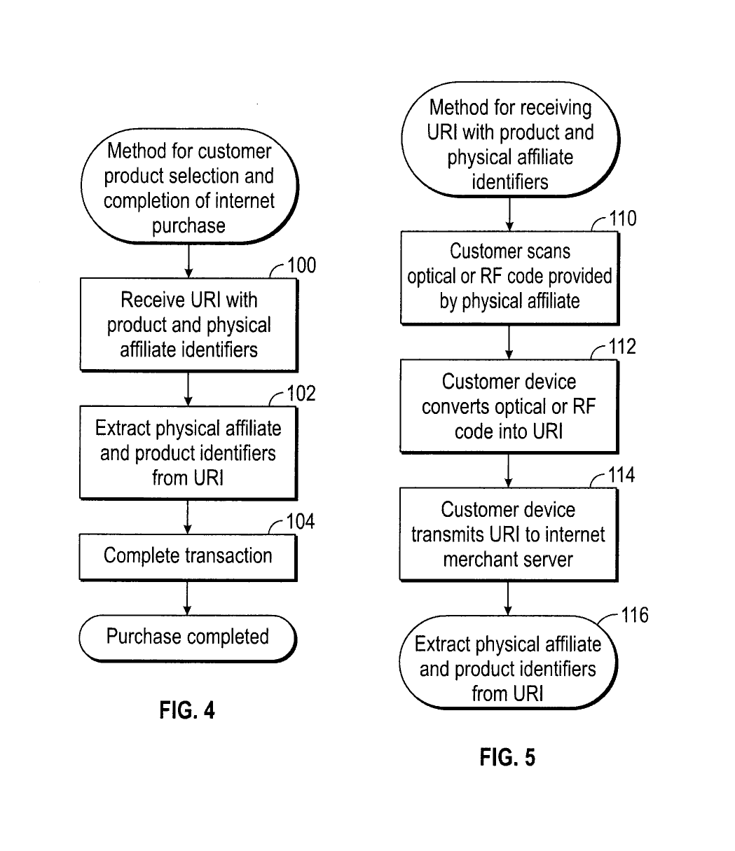

Referring now to FIG. 4, therein shown is an exemplary method for customer product selection and completion of an internet purchase referred to in FIG. 3. The first step in the method for the customer product selection is for the customer 22 to receive a URI with the product and physical affiliate identifiers 62 and 64, respectively, as indicated by block 100. The physical affiliate and product identifiers 62 and 64 are extracted from the URI as indicated by block 102. The transaction may then be completed and the purchase may then be completed, as indicated by block 104, for example in the manner shown in the method described with reference to FIG. 2.

Referring now to FIG. 5, therein shown is an exemplary method for receiving the URI with product and physical affiliate identifiers. The first step in the method for receiving the URI with product and physical affiliate identifiers is for the customer 22 to scan the optical or radio frequency code provided by the physical affiliate 18, as indicated by block 110. The customer device, e.g. the client device 14, may then convert the optically or radio frequency readable code 58 into the URI, as indicated by block 112. The customer 22 device may then transmit the URI to the internet merchant 24 web server 32, as indicated by block 114. Finally, the physical affiliate and product identifiers, 62 and 64, respectively, are extracted from the URI, as indicated by block 116.

The general embodiments of the present inventive methods are intended to work primarily for products that are suitable to be delivered digitally, and where the customer 22 often likes to browse in person before purchasing. The nature of digital products lends itself well to this method, for example, many media stores purchase their products directly from the publisher. Until recently, digital media were distributed the same way, but now customers 22 may wish to browse physical media but consume a digitally delivered copy (which may also cost less). The methods described herein allow the customer 22 that flexibility while still enabling the publisher to credit the physical affiliate 18 for introducing the customer 22 to the product. Additionally, the methods lower the cost of the product to the physical affiliate 18 because the methods can reduce or eliminate many of the display copies, as well as reducing the load on transaction processing by the affiliate 18. Loss prevention is also minimized if the affiliate 18 is distributing primarily low-cost (no retail value) cards or flyers or providing an electronic display catalog.

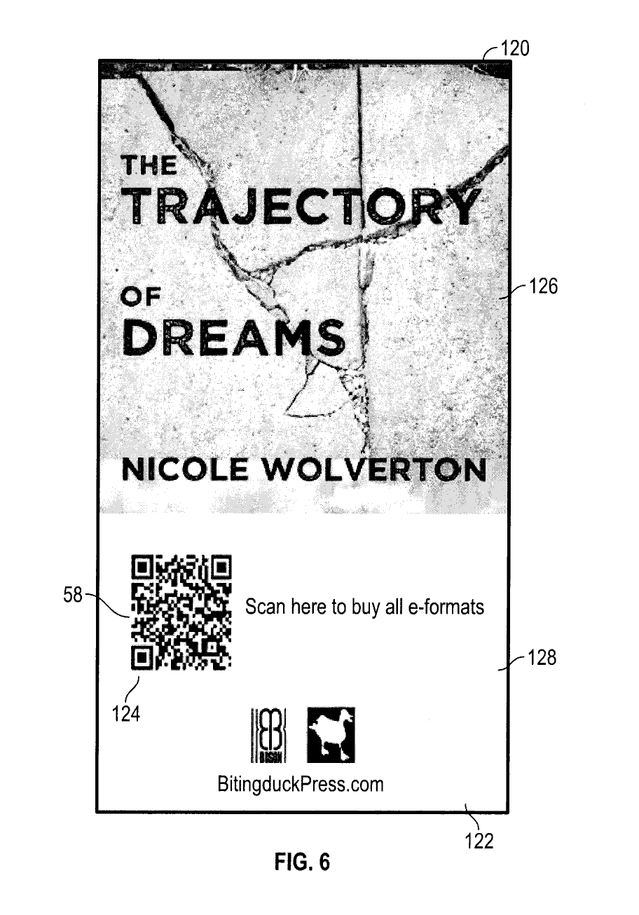

Shown in FIG. 6 is a product identifier card 120 having the optically or radio frequency readable code 58 printed or otherwise attached to a card, flyer, poster, or other article as discussed above. The product identifier card 120, on which the optically or radio frequency readable code 58 may reside may have a substrate 122, a first information 124, and a second information 126. The substrate may have a first surface 128 and a second surface (not shown) opposite the first surface 128. The first information 124 may be printed on at least one of the first surface 128 and the second surface of the substrate 122. The first information 124 may be indicative of a product and an affiliate 18. For example, as shown in FIG. 6, the first information 124 may be the optically or radio frequency readable code 58, described above. As previously described, the optically or radio frequency readable code 58 may include the product and physical affiliate identifiers 62 and 64, respectively. The second information 126 may represent a digital product, as described above, identified by the first information 124. For example, the second information 126 may be a product description, as referenced above, such as a product artwork, a product title, a summary of the product, or a synopsis of a product.

The optically or radio frequency readable code 58 may be presented on the product identifier card 120 which may be in the form of a card, flyer, sticker, poster, or other display with or without a physical instantiation of the product nearby. The optically or radio frequency readable code 58 may also be presented on a card, flyer, poster, or other handout that can be distributed over a geographic area or by a mobile vendor (who then has no need to handle customer transactions directly). The optically or radio frequency readable code 58 may also be displayed on a computer display, for example by having a browsable catalog of electronic books and music on an electronic display in a store, with the optically or radio frequency readable code 58 displayed on the screen with a description or sample of the product. The optically or radio frequency readable code 58 may also be displayed in a non-traditional location for selling digital content, such as flyers, posters, postcards, or electronically in a coffee shop that would like to sell books or music (possibly staff picks) but doesn't want to maintain stock or handle the additional overhead of digital media products. In fact, the location of the client device 14 may not be taken into account during the transaction. The optically or radio frequency readable code 58 may also be distributed door to door, such as in a catalog for a fundraiser or school sale, so that an organization could distribute catalogs or cards with the optically or radio frequency readable codes 58 and product descriptions over a geographic area and customers 22 may browse and purchase on their own, with the organization being credited for the sales (also eliminating the need to deliver and handle products). There are many more possibilities for presentation of the optically or radio frequency readable codes 58 (e.g. authors or musical artists could sell electronic copies of their works at public appearances and get credit as an affiliate seller in addition to their normal royalty). The optically or radio frequency readable codes 58 could be supplied to roving vendors at events such as movie, book, or music festivals so that customers 22 can buy media products on the spot, with the roving vendor being credited for the sale and no requirement for directly handling money or credit cards. The optically or radio frequency readable code 58 could be supplied at airports, bus stations, and train stations so that travelers can browse in the terminal, take a promotional card with the optically or radio frequency readable code 58 for the product, and later purchase the product (e.g. even in flight) while the vendor who introduced the traveler to the product is credited for the sale. The optically or radio frequency readable codes 58 could be provided in waiting rooms so that customers, patients, or clients can browse relevant reading matter and then purchase the product later by scanning the card should they desire their own copy or additional information. This method could also be used to provide a rack of reading material (in the form of cards with descriptions and the optically or radio frequency readable codes 58) for Laundromats or other unstaffed self-service locations. This method would provide additional income to the Laundromat owner (the affiliate) without the need to handle additional transactions or manage stock and loss prevention, which are difficult in locations that are largely unstaffed.

Although the disclosure has been described with reference to the above examples, it will be understood that modifications and variations are encompassed within the spirit and scope of the disclosure. Accordingly, the disclosure is limited only by the following claims.

What is claimed is:

1. A computer program product for providing credit to an affiliate for a purchase from an internet merchant, the computer program product comprising:
a non-transitory processor readable medium comprising:
computer-readable program code for receiving product information identifying a digital product or group of digital products for purchase via a port of a communication device of a computer system, the product information obtained via a client device from an item identifiying the digital product and an affiliate;
computer-readable program code for determining that a digital product was purchased from the internet merchant via the client device;
computer-readable program code for delivery of the digital product to a recipient device; and
computer-readable program code for providing a credit to the affiliate based on determining that the product information obtained via the client device identifies the affiliate and determining that the digital product was purchased from the internet merchant using the product information.

2. The computer program product of claim 1, wherein the affiliate is distinct from the internet merchant.

3. The computer program product of claim 2, wherein the affiliate is an author of the digital product.

4. The computer program product of claim 1, wherein the information is an optically or radio frequency readable code.

5. The computer program product of claim 4, wherein the information indicative of the affiliate includes an affiliate code.

6. The computer program product of claim 4, wherein the product information comprises a first information and a second information, the first information indicative of the digital product and the second information indicative of the affiliate, and wherein the first and second information are distinct optically or radio frequency readable codes.

7. The computer program product of claim 4, wherein the optically or radio frequency readable code is linked to an internet site of the internet merchant and the digital product is determined to be purchased from the internet merchant via the device using the internet site linked to the optically or radio frequency readable code.

8. The computer program product of claim 1, wherein the digital product is made available by at least one of electronically mailing the digital product, a download from a server controlled by the internet merchant, a download from a party authorized by the internet merchant.

9. The computer program product of claim 1, wherein the item from which the information is obtained is remote from a location of the affiliate at a time the information is obtained.

10. A processor readable medium storing one or more software program that when executed by a processor causes the processor to:
receive product information identifying a digital product or group of digital products for purchase and an affiliate via a port of a communication device of a computer system, the product information obtained via a client device from an item identifying the digital product and an affiliate;
determine that the digital product was purchased by a user of the client device from an internet merchant via the client device;
deliver the digital product or group of digital products to a user of the client device; and
provide a credit to the affiliate based on determining that the product information identifies the affiliate and determining that the digital product was purchased from the internet merchant using the product information.

11. The processor readable medium of claim 10, wherein the affiliate is distinct from the internet merchant.

12. The processor readable medium of claim 11, wherein the affiliate is an author of the digital product.

13. The processor readable medium of claim 10, wherein the information is an optically or radio frequency readable code.

14. The processor readable medium of claim 13, wherein the information indicative of the affiliate includes an affiliate code.

15. The processor readable medium of claim 13, wherein the information comprises a first information and a second information, the first information indicative of the digital product and the second information indicative of the affiliate, and wherein the first and second information are distinct optically or radio frequency readable codes.

16. The processor readable medium of claim 13, wherein the optically or radio frequency readable code is linked to an internet site of the internet merchant and the digital product is determined to be purchased from the internet merchant by the user using the internet site linked to the optically or radio frequency readable code.

17. The processor readable medium of claim 10, wherein the digital product is made available by at least one of electronically mailing the digital product, a download from a server controlled by the internet merchant, a download from a party authorized by the internet merchant.

18. The processor readable medium of claim 10, wherein the item from which the information is obtained is remote from a location of the affiliate at a time the information is obtained.

19. A processor readable medium storing one or more software program that when executed by a processor causes the processor to:
receive information indicative of a digital product for purchase and an affiliate via a port of a communication device of a computer system, the information obtained from an item associated with the affiliate and received from a client device, and wherein the information is an optically or radio frequency readable code linked to an internet site of a predetermined internet merchant;
effect a transaction for the digital product with the client device;
make the digital product available to a recipient device; and
provide a credit to the affiliate based on determining that the information identifies the affiliate and determining that the digital product was purchased from the internet merchant using the information.

20. The processor readable medium of claim 19, wherein the affiliate is distinct from the internet merchant.

21. The processor readable medium of claim 20, wherein the affiliate is an author of the digital product.

22. The processor readable medium of claim 19, wherein the optically or radio frequency readable code includes an affiliate code.

23. The processor readable medium of claim 19, wherein the optically or radio frequency readable code comprises a first optically or radio frequency readable code and a second optically or radio frequency readable code, the first optically or radio frequency readable code indicative of the digital product and the second optically or radio frequency readable code indicative of the affiliate.

24. The processor readable medium of claim 19, wherein the item from which the information is obtained is remote from a location of the affiliate at a time the information is obtained.

25. The processor readable medium of claim 19, wherein the information is received from the client device without determining a location of the client device.

26. A product identifier card, comprising:
a substrate having a first surface and a second surface opposite the first surface;
a first information affixed to at least one of the first and second surfaces of the substrate, the first information indicative of a product and an affiliate; and
a second information affixed to at least one of the first and second surfaces of the substrate, the second information representing a digital product identified by the first information.

27. The product identifier card of claim 26, wherein the first information is further indicative of an internet merchant.

28. The product identifier card of claim 26 further comprising a third information indicative of an internet merchant.

29. The product identifier card of claim 26, wherein the first information is an optically or radio frequency readable code.

30. The product identifier card of claim 29, wherein the optically or radio frequency readable code is linked to an internet site of an internet merchant and, when read by a client device, directs the client device to the internet site.

31. The product identifier card of claim 30, wherein the internet site receives the information indicative of the product and the affiliate.

32. The product identifier card of claim 29, wherein the optically or radio frequency readable code is a code indicative of a relationship between the product and the affiliate.

33. The product identifier card of claim 29, wherein the optically or radio frequency readable code comprises a first optically or radio frequency readable code and a second optically or radio frequency readable code, the first optically or radio frequency readable code indicative of the digital product and the second optically or radio frequency readable code indicative of the affiliate.

34. The product identifier card of claim 26, wherein the affiliate is distinct from an internet merchant.

35. The product identifier card of claim 34, wherein the affiliate is an author of the digital product.

36. The product identifier card of claim 26, wherein the information indicative of the affiliate includes an affiliate code.

37. A system for providing credit to an affiliate for a purchase from an internet merchant different from the affiliate, the system comprising:
a product identifier card having a substrate, a first information affixed to the substrate, and a second information affixed to the substrate, the first information indicative of a digital product and an affiliate, the second information representing a digital product identified by the first information;
a client device configured to read the first information;
a computer system having a processor, a non-transitory processor readable medium in communication with the processor, and a communication device having at least one port and in communication with the processor, the computer system receiving the first information identifying the digital product and the affiliate from the client device via the port of the communication device of the computer system, the first information obtained from the product identifier card associated with the affiliate;
a database stored on a non-transitory processor readable medium, the database storing second information indicative of a plurality of affiliates; and
an affiliate crediting module having one or more software program stored on a non-transitory processor readable medium that when executed causes a processor to:
determine an identity of the affiliate from the first information and the second information;
determine whether the digital product was purchased from an internet merchant associated with the database and the computer system; and
provide credit to the affiliate within the database based on determining that the first information identifies the affiliate and determining that the digital product was purchased from the internet merchant using the information.

38. The system of claim 37, wherein the affiliate is distinct from the internet merchant.

39. The system of claim 37, wherein the affiliate is an author of the digital product.

40. The system of claim 37, wherein the first information is indicative of an optically or radio frequency readable code.

41. The system of claim 40, wherein the optically or radio frequency readable code includes an affiliate code.

42. The system of claim 40, wherein the optically or radio frequency readable code comprises a first optically or radio frequency readable code and a second or radio frequency optically readable code, the first optically or radio frequency readable code indicative of the digital product and the second optically or radio frequency readable code indicative of the affiliate.

43. The system of claim 37, wherein the item from which the information is obtained is remote from a location of the affiliate at a time the information is obtained.

44. The system of claim 37, wherein the information is received from the client without determining a location of the client.

45. The system of claim 37, wherein the information is received from the client via a client device without determining a location of the client device.

46. The system of claim 37, wherein the product identifier card associated with the affiliate is not at a location of the affiliate.
